(19) United States
(12) Patent Application Publication
(10) Pub. No.: US 2005/0213149 A1
(43) Pub. Date: Sep. 29, 2005

(54) Printing device

(75) Inventor: Tetsuya Kuwahara, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/077,484

(22) Filed: Mar. 8, 2005

(30) Foreign Application Priority Data
Mar. 25, 2004 (JP) 2004-088813

(51) Int. Cl. G06F 15/00

(52) U.S. Cl. 358/1.15

(57) ABSTRACT

An image printing device includes a plurality of input ports which input image information and a control unit that decides a priority order for determining a presence or an absence of an input of the image information for the plurality of input ports in accordance with an input time of the image information at each of the plurality of input ports.

### BACKGROUND OF THE INVENTION

1. Field of the Invention

The present invention relates to a printing device which prints out image information input from an external device via a plurality of input ports.

2. Description of Related Art

A recent multifunction facsimile machine (a facsimile Multi-Function Peripheral (MFP)) includes a conventional copy function and a facsimile function, and in addition, a transmitting function and a printer function. According to the transmitting function, the facsimile MFP transmits to another facsimile machine, image information transmitted from a Personal Computer (PC) via a Local Area Network (LAN) or a PC connected to a Universal Serial Bus (USB). According to the printer function, the facsimile MFP prints out the image information.

In such a facsimile MFP having the copy function, the facsimile function and the printer function, a priority order can be set for each function. While a printing process by a certain function is carried out, in case a printing request of a function having a higher priority order than the function currently carrying out the printing process is generated, the printing process currently being carried out is interrupted and the printing process of the function having a higher priority order is executed preferentially. Another conventional printing device inputs a plurality of pieces of image information, each having a priority, and prints out the image information according to a priority order.

In a printing device which inputs image data for printing from an external device via a plurality of input ports like the above-described facsimile MFP, to execute the printing process of the image information efficiently, an efficient control is necessary for the plurality of input ports. In case of not carrying out a special input control on the input ports, the image information is input from the plurality of input ports at the same time. Thus, there is a drawback that an image memory with a large capacity is necessary to be provided.

### SUMMARY OF THE INVENTION

The present invention has been made in consideration of the above-described circumstances. An advantage of the present invention is to provide a printing device which can efficiently control a plurality of input ports.

Another advantage of the present invention is to provide a printing device which can prevent image information from different external devices from being mixed and which can carry out a printing process of image information input from a plurality of input ports even by using an image memory with a small capacity.

Another advantage of the present invention is to provide a printing device which can enable an external device to easily learn the fact that a printing process is being carried out and image information cannot be input.

According to an aspect of the present invention, a printing device includes a plurality of input ports and prints out image information input from the input ports. The printing device includes a unit which decides a priority order for determining the presence or the absence of an input of image information for the plurality of input ports in accordance with an input time of the image information at each of the plurality of input ports.

Accordingly, the priority order for determining the presence or the absence of the input of the image information is decided in accordance with the input time of the image information at each of the plurality of input ports. That is, a determination is made as to whether or not the input of the image information is preferentially accepted at an input port which has a late input time for the image information and is used at a time close to a current time. Specifically, for the input port which is used at the time close to the current time and has a high priority, a detection is made as to whether or not image information is input over a prescribed period of time. In case the image information is input, the input image information is printed. In case the image information is not input to the input port having a high priority for a prescribed period of time, the same processing is carried out for the input port ranked next in the priority order. Accordingly, the printing process can be carried out preferentially for the input port having the late input time, in other words, the recently used input port. Therefore, in case the image information is input consecutively from the same input port, the efficiency of the printing process improves. Further, since a history of the input time is updated sequentially, a processing can be carried out according to the latest input time.

According to another aspect of the present invention, the printing device includes a unit which prohibits an input of image information from another input port in case image information is being input from one input port of the plurality of input ports.

Accordingly, in case the image information is input from one input port, the input of the image information from another input port is prohibited. Thus, a large volume of image information is not input at the same time. As a result, the image information can be prevented from being mixed and without providing an image memory with a large capacity, an image memory with a small capacity can be used.

According to another aspect of the present invention, the printing device also includes a transmitting unit. When image information is input from one input port of the plurality of input ports and a printing process is carried out, in case of receiving an input request of image information to another input port from an external device, the transmitting unit transmits information indicating that the printing process is being carried out to the external device.

Accordingly, when the image information is input from one input port and the printing process is carried out, in case of receiving the input request of the image information to another input port from the external device, information indicating that the printing process is being carried out (a busy signal) is transmitted to the external device. As a result, without misunderstanding that the printing device has a failure or the like, the external device can be on standby for the transmission process of the image information.

According to the aspect of the present invention, in accordance with the stored input time of the image information at each of the input ports, the priority order for determining the presence or the absence of the input of the image information is decided. Therefore, the printing process can be carried out preferentially for the input port having a later input time, in other words, the input port used at a time closer to the current time. Thus, in case the image information is input consecutively from the same input port, the efficiency of the printing process can be improved.

According to the aspect of the present invention, when the image information is input from a certain input port, the input of the image information from another input port is prohibited. Therefore, the image information from different external devices can be prevented from being mixed and an image memory with a small capacity can be used.

According to the aspect of the present invention, when the image information is input from a certain input port and the printing process is carried out, in case of receiving the input request of the image information to another input port from the external device, information indicating that the printing process is being carried out is transmitted to the external device. Therefore, the external device can easily learn the fact that the printing process is being carried out and the image information cannot be input.

### BRIEF DESCRIPTION OF THE SEVERAL VIEWS OF THE DRAWINGS

FIG. 1 is a block diagram showing a configuration of a facsimile MFP according to an embodiment of the present invention.

FIG. 2 is a flowchart showing an example of an operation procedure of a printing process of image data transmitted from an external PC carried out in a facsimile MFP according to an embodiment of the present invention.

FIG. 3 is a flowchart showing an example of an operation procedure of a printing process of image data transmitted from an external PC carried out in a facsimile MFP according to an embodiment of the present invention.

### DETAILED DESCRIPTION OF THE INVENTION

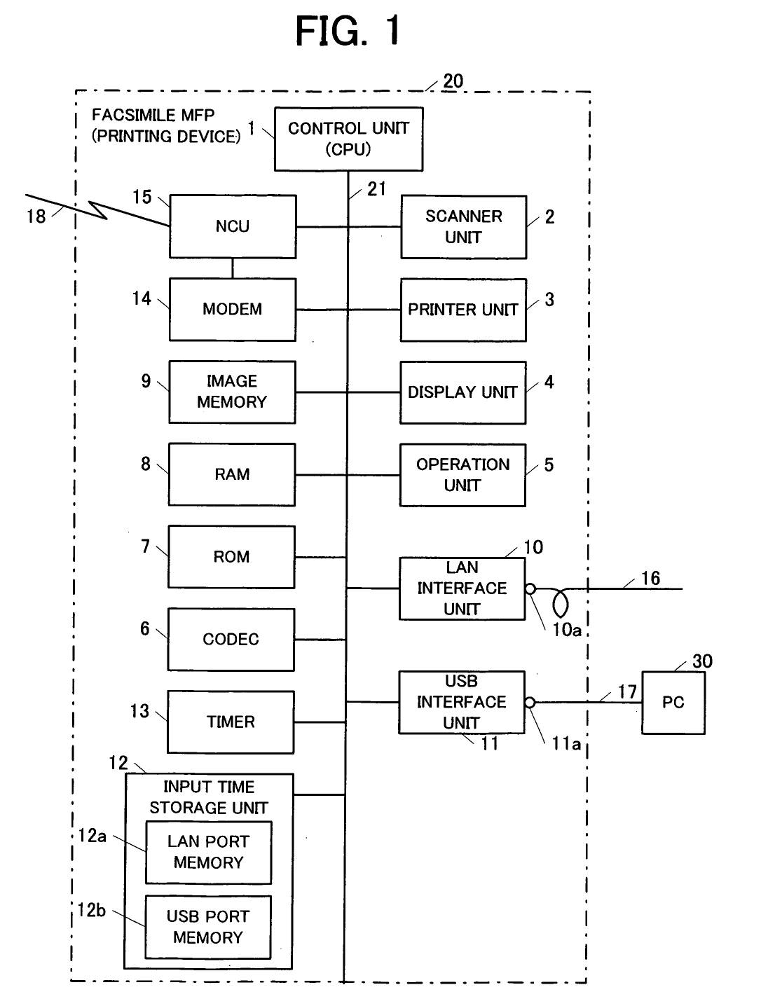

Referring to the drawings, an embodiment of the present invention will be described. FIG. 1 is a block diagram showing a configuration of a facsimile MFP 20 as a printing device according to an embodiment of the present invention.

The facsimile MFP 20 includes a control unit 1, a scanner unit 2, a printer unit 3, a display unit 4, an operation unit 5, a codec 6, a Read Only Memory (ROM) 7, a Random Access Memory (RAM) 8, an image memory 9, a LAN interface unit 10, a USB interface unit 11, an input time storage unit 12, a timer 13, a modem 14 and a Network Control Unit (NCU) 15 or the like. The facsimile MFP 20 includes a scanning function, a printing function and a transmitting function. According to the scanning function, the facsimile MFP 20 scans an original document by the scanner unit 2 and obtains image data. According to the printing function, the facsimile MFP 20 prints out an image by the printer unit 3 in accordance with the scanned image data, image data received by facsimile communication or image data received from an external PC via the LAN interface unit 10 or the USB interface unit 11. According to the transmitting function, the MFP 20 carries out facsimile transmission of the scanned image data or the received image data.

The control unit 1 includes a clocking unit (not shown) for clocking a time (year, month, date, hour, minute and second). Specifically, the control unit 1 is formed with a Central Processing Unit (CPU). The control unit 1 is connected to the above-described hardware components of the facsimile MFP 20 via a bus 21. The control unit 1 controls each of the hardware components and executes various software functions in accordance with a control program stored in the ROM 7. The scanner unit 2 scans an original document by an optical system using a Charge Coupled Device (CCD) or the like and outputs scanned image data. The printer unit 3 is an electrophotographic printer device and prints out an image onto paper according to the image data of the original document scanned by the scanner unit 2, the image data received by the facsimile communication, the image data transmitted from the remote PC or the like.

The display unit 4 is a display device such as a Liquid Crystal Display (LCD) or a Cathode Ray Tube (CRT) display. The display unit 4 displays an operational state of the facsimile MFP 20 and a screen for urging the user to carry out an operation and an input. The display unit 4 also displays image data of an original document scanned to be transmitted, image data transmitted from another facsimile machine or a PC or the like. The operation unit 5 includes a character key, a ten-key numeric pad, a speed-dial key, a one-touch dial key and various function keys or the like necessary for operating the facsimile MFP 20. Further, by providing the display unit 4 as a touch panel, a part or all of the various keys of the operation unit 5 can be substituted.

The codec 6 encodes and compresses image data and decodes encoded and compressed image data. The ROM 7 previously stores various software programs necessary for an operation of the facsimile MFP 20. The RAM 8 is formed with a Static RAM (SRAM), a flash memory or the like. The RAM 8 stores temporary data that is generated when software is executed. The image memory 9 is formed with a Dynamic RAM (DRAM) or the like. The image memory 9 accumulates image data scanned and encoded from an original document, image data received from another facsimile machine or a PC and encoded, or the like.

The LAN interface unit 10 includes a LAN port 10a. The LAN interface unit 10 is connected to a remote PC, which is an external device, via a LAN 16. The LAN interface unit 10 exchanges data with the remote PC. Image data for printing received from the remote PC is input to the LAN port 10a. The USB interface unit 11 includes a USB port 11a. The USB interface unit 11 is connected to a neighboring PC 30, which is an external device, via a USB 17. The USB interface unit 11 exchanges data with the neighboring PC 30. Image data for printing received from the neighboring PC 30 is input to the USB port 11a. Various image data created and edited by these PCs is transmitted to the facsimile MFP 20 via the LAN 16 or the USB 17, and input to the LAN port 10a of the LAN interface unit 10 or the USB port 11a of the USB interface unit 11. The facsimile MFP 20 (the printer unit 3) prints out onto paper, an image according to the input image data.

The input time storage unit 12 stores an input time of the image data at each of the LAN port 10a and the USB port 11a. The input time storage unit 12 includes a LAN port memory 12a and a USB port memory 12b. The LAN port memory 12a stores a recent input time of the image data at the LAN port 10a. The USB port memory 12b stores a recent input time of the image data at the USB port 11a. At a point of time when an input process of the image data at the LAN port 10a or the USB port 11a ends, a current time clocked by the clocking unit of the control unit 1 is stored in the LAN port memory 12a or the USB port memory 12b. A latest input time is stored in the input time storage unit 12 at all times. The timer 13 clocks a prescribed period of time T (a monitoring time for monitoring the presence or the absence of an input of the image data to the LAN port 10a or the USB port 11a).

The modem 14 is connected to the bus 21 and is formed with a faxmodem which can carry out facsimile communication. The modem 14 is connected directly to the NCU 15 which is also connected to the bus 21. The NCU 15 is hardware which carries out an operation to close and release a network line 18 for a Public Switched Telephone Network (PSTN). The NCU 15 connects the modem 14 and the PSTN according to necessity. The facsimile MFP 20 is connected to another facsimile machine via the PSTN so that general facsimile communication can be carried out.

In the facsimile MFP 20 having the above-described configuration, the image data is input to the LAN port 10a of the LAN interface unit 10 or the USB port 11a of the USB interface unit 11 via the LAN 16 or the USB 17 from the remote PC or the neighboring PC 30, which are the external devices. The printer unit 3 prints out onto paper, an image according to the input image data. In this case, by comparing recent input times of the image data at the LAN port 10a and the USB port 11a stored in the input time storage unit 12, the input port having the later input time is set as a priority port. The facsimile MFP 20 monitors for a prescribed period of time, whether or not image data has been input from the priority port. In case the image data has been input, the printer unit 3 carries out a printing process of an image according to the input image data. In case the image data is not input from the priority port within a prescribed period of time, the facsimile MFP 20 monitors for a prescribed period of time, whether or not image data is input from an input port that is not the priority input port. In case the image data is input, the printer unit 3 carries out a printing process of an image according to the input image data.

When the image data is being input from one of the LAN port 10a and the USB port 11a, an input of image data from another input port is prohibited. When the image data is being input from one PC via one input port, in case of receiving an input request of the image data from another PC via another input port, a busy signal is transmitted to the other PC to notify the other PC a fact that the printing process is being executed by another PC.

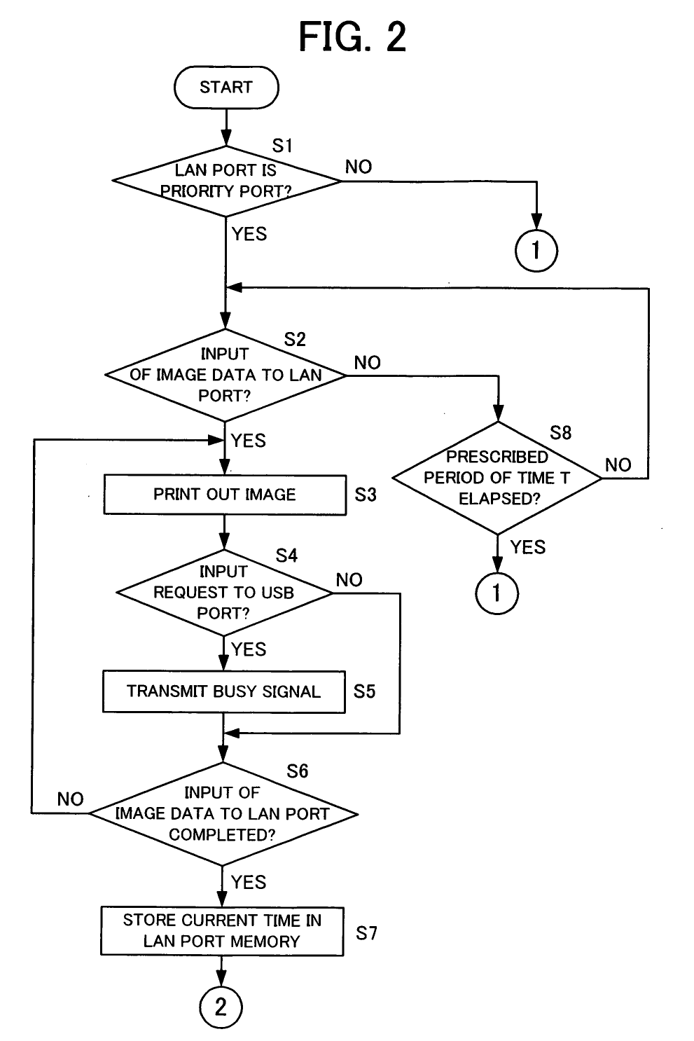

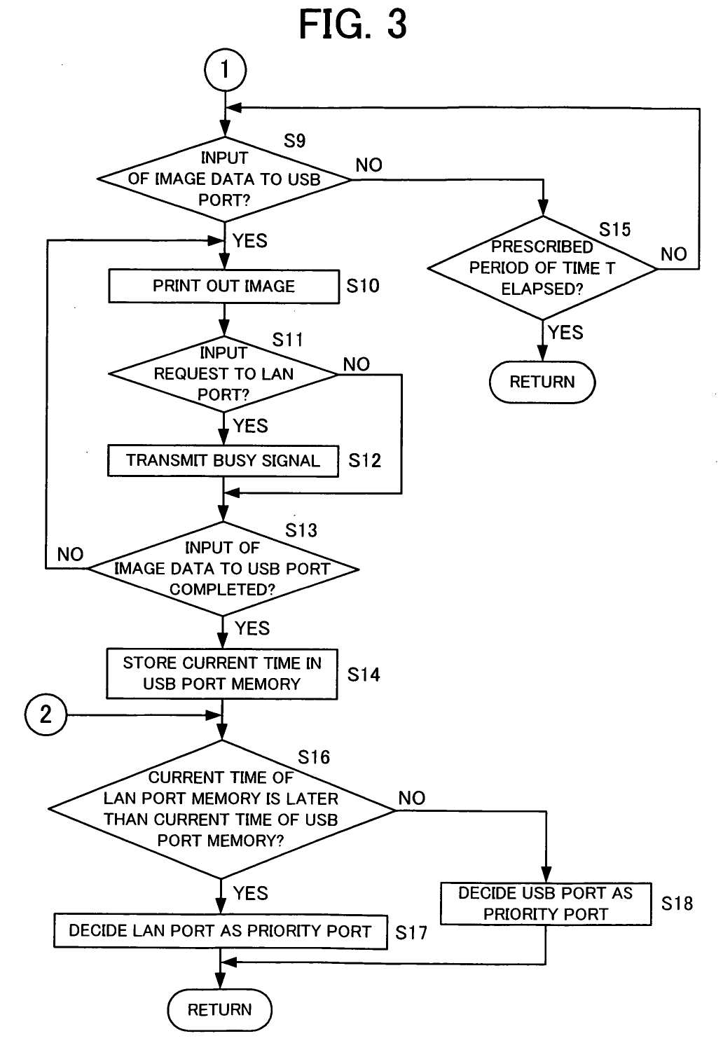

In the following, a description will be made of an operation of a printing process of image data transmitted from an external PC carried out in the facsimile MFP 20 according to an embodiment of the present invention. FIG. 2 and FIG. 3 are flowcharts showing an example of this operation procedure.

First, the control unit 1 determines whether or not the LAN port 10a is a priority port in accordance with a stored content of the input time storage unit 12 (a recent input time of the image data at the LAN port 10a and the USB port 11a) (step S1). In case the LAN port 10a is a priority port (step S1: YES), the control unit 1 determines whether or not image data is input from a remote PC to the LAN port 10a (step S2). In case the image data is input (step S2: YES), the printer unit 3 prints out onto paper, an image according to the input image data (step S3). During the printing process, the control unit 1 determines the presence or the absence of an input request of the image data to the USB port 11a from the neighboring PC 30 (step S4). In case of the presence of the input request (step S4: YES), the input is prohibited and a busy signal is transmitted to the neighboring PC 30 (step S5) and the operation proceeds to step S6. Meanwhile, in case of the absence of the input request (step S4: NO), the operation proceeds directly to step S6.

The control unit 1 determines whether or not the input of the image data to the LAN port 10a has been completed in accordance with the presence or the absence of an input of a completion command signal from the remote PC (step S6). In case the input has not been completed (step S6: NO), the operation returns to step S3 and the operation of steps S3 through S5 is continued. In case the input of the image data to the LAN port 10a has been completed (step S6: YES), a current time clocked by the clocking unit of the control unit 1 is stored in the LAN port memory 12a (step S7) and the operation proceeds to step S16.

Further, in case of the absence of the input of the image data to the LAN port 10a (step S2: NO), the control unit 1 determines whether or not a prescribed period of time T has elapsed in accordance with the clocking result of the timer 13 (step S8). In case the prescribed period of time T has not elapsed yet (step S8: NO), the operation returns to step S2 and a monitoring of the presence or the absence of the input of the image data to the LAN port 10a is continued.

In case the prescribed period of time T has elapsed (step S8: YES), or in case the LAN port 10a is not the priority port (step S1: NO), in other words, in case the USB port 11a is the priority port, the control unit 1 determines the presence or the absence of an input of image data to the USB port 11a from the neighboring PC 30 (step S9). In case of the presence of the input of the image data (step S9: YES), the printer unit 3 prints out onto paper, an image according to the input image data (step S10). During the printing process, the control unit 1 determines the presence or the absence of an input request of the image data to the LAN port 10a from the remote PC (step S11). In case of the presence of the input request (step S11: YES), the input is prohibited and a busy signal is transmitted to the remote PC (step S12) and the operation proceeds to step S13. In case of the absence of the input request (step S11: NO), the operation proceeds directly to step S13.

The control unit 1 determines whether or not the input of the image data to the USB port 11a has been completed in accordance with the presence or the absence of an input of a completion command signal from the neighboring PC 30 (step S13). In case the input has not been completed (step S13: NO), the operation returns to step S10 and the operation of steps S10 through S12 is continued. In case the input of the image data to the USB port 11a has been completed (step S13: YES), a current time clocked by the clocking unit of the control unit 1 is stored in the USB port memory 12b (step S14) and the operation proceeds to step S16.

Further, in case of the absence of the input of the image data to the USB port 11a (step S9: NO), the control unit 1 determines whether or not the prescribed period of time T has elapsed in accordance with the clocking result of the timer 13 (step S15). In case the prescribed period of time T has not elapsed yet (step S15: NO), the operation returns to step S9 and a monitoring of the presence or the absence of the input of the image data to the USB port 11a is continued. In case the prescribed period of time T has elapsed (step S15: YES), the operation returns.

The control unit 1 determines whether or not the current time stored in the LAN port memory 12a is later than the current time stored in the USB port memory 12b (step S16). In case the time of the LAN port memory 12a is later than the time of the USB port memory 12b (step S16: YES), the LAN port 10a is decided as the priority port (step S17) and the operation returns. Meanwhile, in case the time of the USB port memory 12b is later than the time of the LAN port memory 12a (step S16: NO), the USB port 11a is decided as the priority port (step S18) and the operation returns.

Further, in the above-described flowcharts, in case of the presence of the input request from the remote PC (step S11: YES), a busy signal is transmitted to the remote PC (step S12). However, in case of the presence of the input request from the remote PC (step S11: YES), the input request may be ignored.

Further, in the above-described example, two input ports, the LAN port 10a and the USB port 11a, have been described as a plurality of input ports. However, another input port such as a parallel port can be adopted. Moreover, in the above-described example, the time of the latest input process of the image data at the LAN port 10a or the USB port 11a is stored in the input time storage unit 12. However, a LAN port flag and a USB flag can be used. In this case, at a point of time when the input process of the image data at the LAN port 10a or the USB port 11a ends, a corresponding LAN port flag or USB port flag can be set “1”. The other USB port flag or the LAN port flag can be set “0”. The port which the flag is “1” can be managed as a priority port.

In the above-described embodiment, the facsimile MFP is described as an example. However, the present invention can be applied to all printing devices having a plurality of input ports to input image data for printing.

1. An image printing device, comprising:
a plurality of input ports which input image information; and
means for deciding a priority order for determining a presence or an absence of an input of the image information for the plurality of input ports in accordance with an input time of the image information at each of the plurality of input ports.

2. The image printing device according to claim 1, further comprising means for prohibiting the input of the image information from another input port in case the image information is being input from one input port of the plurality of input ports.

3. The image printing device according to claim 1, further comprising means for transmitting, wherein when the image information is input from one input port of the plurality of input ports and a printing process is carried out, in case of receiving an input request of the image information for another input port from an external device, the means for transmitting transmits information indicating that the printing process is being carried out to the external device.

4. The image printing device according to claim 2, further comprising means for transmitting, wherein when the image information is input from one input port of the plurality of input ports and a printing process is carried out, in case of receiving an input request of the image information for another input port from an external device, the means for transmitting transmits information indicating that the printing process is being carried out to the external device.

5. A control method of an image printing device, comprising:
inputting image information from any one of a plurality of input ports; and
deciding a priority order for determining a presence or an absence of an input of the image information for the plurality of input ports in accordance with an input time of the image information at each of the plurality of input ports.

6. The control method of the image printing device according to claim 5, further comprising prohibiting the input of the image information from another input port in case the image information is being input from one input port of the plurality of input ports.

7. The control method of the image printing device according to claim 5, further comprising transmitting information indicating that a printing process is being carried out to an external device in case of receiving an input request of the image information for another input port from the external device when the image information is input from one input port of the plurality of input ports and the printing process is carried out.

8. The control method of the image printing device according to claim 6, further comprising transmitting information indicating that a printing process is being carried out to an external device in case of receiving an input request of the image information for another input port from the external device when the image information is input from one input port of the plurality of input ports and the printing process is carried out.

9. An image printing device, comprising:
a plurality of input ports which input image information; and
a control unit that decides a priority order for determining a presence or an absence of an input of the image information for the plurality of input ports in accordance with an input time of the image information at each of the plurality of input ports.

10. The image printing device according to claim 9, further comprising a prohibiting unit that prohibits the input of the image information from another input port in case the image information is being input from one input port of the plurality of input ports.

11. The image printing device according to claim 9, further comprising a transmitting unit, wherein when the image information is input from one input port of the plurality of input ports and a printing process is carried out, in case of receiving an input request of the image information for another input port from an external device, the transmitting unit transmits information indicating that the printing process is being carried out to the external device.

12. The image printing device according to claim 10, further comprising a transmitting unit, wherein when the image information is input from one input port of the plurality of input ports and a printing process is carried out, in case of receiving an input request of the image information for another input port from an external device, the transmitting unit transmits information indicating that the printing process is being carried out to the external device.

13. The image printing device according to claim 1, further comprising means for storing the input time of the image information.

14. The image printing device according to claim 9, further comprising a storage unit that stores the input time of the image information.

15. The control method of the image printing device according to claim 5, further comprising storing the input time of the image information.

16. The image printing device according to claim 1, further comprising means for printing an image.

17. The image printing device according to claim 9, further comprising a printer that prints out an image.

18. The control method of the image printing device according to claim 5, further comprising printing out an image.

19. The image printing device according to claim 1, further comprising an input storage unit.

20. The image printing device according to claim 9, further comprising a input storage unit.
